(19) United States
(12) Patent Application Publication
(10) Pub. No.: US 2013/0207401 A1
(43) Pub. Date: Aug. 15, 2013

(54) HIGH EFFICIENCY RADIOISOTOPE THERMODYNAMIC ELECTRICAL GENERATOR

(71) Applicants: Saade Youssef MAKHLOUF, Beirut (LB); Khalil Ezzeddine, Beirut (LB)

(72) Inventors: Saade Youssef MAKHLOUF, Beirut (LB); Khalil Ezzeddine, Beirut (LB)

(21) Appl. No.: 13/370,419

(22) Filed: Feb. 10, 2012

(51) Int. Cl. F02C 1/05; H02K 7/18

(52) U.S. Cl. 290/1 R; 60/644.1

(57) ABSTRACT

An electric generator comprises a central cylindrical shielded autoclave fuel capsule made out of metal in which are contained radioisotope fuel rods. A spiral cylindrical heat exchanger encases the fuel capsule. A thermal insulating material insulates the fuel capsule from the cylindrical heat exchanger which encases it to avoid thermal losses. The radioisotope fuel capsule and heat exchanger are contained within a cylindrical housing having a bore formed therein eccentrically located in a cylindrical rotor to form an “eccentric” compression chamber. A number of movable vanes slide radially inwards and outwards in slots formed in the cylindrical rotor. The ends of the vanes are biased against the walls of the eccentric cylinder by means of gas/vapor pressure in the rear part of the radial slots or by spring bias.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### FIELD OF THE INVENTION

The present invention relates to an improvement in power generating devices, in particular radioisotope thermodynamic electrical generators.

### BACKGROUND OF THE INVENTION

A radio-isotope thermoelectric generator (“RTG”) is an electrical generator powered from radioactive decay. In such a device, the heat released by the decay of a suitable radioactive material is converted directly into electricity by the Seebeck effect using an array of thermocouples.

RTGs can be considered as a type of nuclear battery and have been used as power sources in satellites, space probes, and unmanned remote facilities, such as a series of lighthouses built by the former Soviet Union inside the Arctic Circle. RTGs are a suitable power source for robotic applications or maintenance-free situations needing a few hundred watts (or less) of power for durations too long for fuel cells and batteries, or for the economical use of conventional generators, as well as for applications in places where solar cells are not practical. Safe use of RTGs requires containment of the radioisotopes for a long period beyond the productive lifetime of the unit.

Current nuclear batteries often achieve low efficiency. Most of them convert thermal energy into electricity by means of thermocouples or thermo-photovoltaic cells. Unfortunately, these RTGs cannot achieve efficiencies over 10-15%.

Therefore, there is a need for a radioactive isotope electrical generator which operates at high efficiency. According to the present invention this is possible by using efficient thermodynamic Rankin or Brayton cycles in a closed loop system.

### SUMMARY OF THE INVENTION

The generator comprises concentric cylindrical structures with circular cross-sections, apart from the inner wall of the compression chamber, which, while having a cylindrical shape, is eccentrically displaced from the central axis. A central shielded autoclave radio-isotope fuel capsule/reactor is preferably made from very pure metal in order to enable it to withstand high temperature and high pressure conditions as well as to resist neutron irradiation. The capsule contains radioactive fuel, preferably spent fuel, and may optionally be covered with a heavy metal gamma ray (y) protector shield. A metallic spiral cylindrical heat exchanger encases the fuel capsule. A thermal insulating material insulates the fuel capsule from the surrounding cylindrical heat exchanger to avoid thermal losses. The radio-isotope fuel capsule and heat exchanger are contained within the eccentrically displaced cylinder housing or wheel (“Eccentric cylinder”) making up the inner wall of the compression chamber. The rotor of the generator, shaped as a hollow circular cylinder and forming the outer wall of the compression chamber, revolves around the eccentric cylinder in such a way that its rotation axis coincides with the central axis. A number of movable blades or vanes slide in radial slots on the inner surface of the rotor. They are biased towards the eccentric cylinder by appropriate means.

It is an object of the invention to provide a heat motor that is exceptionally safe and reliable, and which has a thermal recovery efficiency of over 85%. This is possible due to its use of a unique high efficiency spiral heat exchanger and its unique closed loop design.

It is another objective of this invention to provide a radioisotope thermodynamic electrical generator where the rotor and stator enclose the fuel capsule to provide compactness and more radiobiological shielding especially if a gamma emitting radioisotope is used as primary source of energy.

It is another object of the invention to provide a radioisotope thermodynamic electrical generator with an advanced heat exchanger in the form of a spiral cylindrical roll with special internal design covering the total body of the reactor and wherein said heat exchanger is thermally insulated.

It is another object of this invention to provide a highly reliable electric power generator wherein several major components are multi-functional. The spiral cylindrical heat exchanger, the cylindrical rotor and the stator provide additional shielding in addition to the actual reactor shielding because they enclose the radiation source.

It is another object of the invention to be used as a means of nuclear waste disposal.

It is another object of the invention to provide a design in which the generator size can vary from few centimeters in diameter to tens of meters depending on the desired power output.

It is an object of the invention to provide a radioisotope thermodynamic electrical generator with a drive motor of the radial vane type wherein vanes slide in radial slots located on the inside of the rotor.

It is another object of this invention to provide a radioisotope thermodynamic electrical generator of the radial vane type in which the asymmetric compression chamber has an inlet port and outlet port.

It is another objective of this invention to provide a radioisotope thermodynamic electrical generator where the rotating drive motor serves as the rotor of the electric generator.

It is another object of the invention to provide a radioisotope thermodynamic electrical generator in which the electric generator rotor and stator may be placed on, above, or adjacent the drive motor (i.e. in a manner not covering the total body of the generator) or be completely separated from the radial vane type drive motor.

In an advantage, in large part because of its use of a unique high efficiency spiral heat exchanger and the unique closed loop design of the invention, this generator can achieve a heat recovery efficiency of over 85% and is exceptionally safe and reliable.

In an advantage, this generator works on a wide range of radioactive isotopes whether natural, synthetic or low cost nuclear wastes.

In an advantage, besides its main role, several key parts of this generator play the role of a biological shield against radiation.

In an advantage, this generator can also be considered as means of nuclear waste disposal.

In an advantage, generators of this kind have a highly variable energy density which depends on the half-life and energy levels of the isotopes, making the generator adaptable to a wide variety of applications

In another advantage, the generator size can vary from few centimeters in diameter to tens of meters depending on the desired power output.

### BRIEF DESCRIPTION OF THE DRAWINGS

FIG. 1 is a view of a cross-section perpendicular to the axis of a radioactive isotope thermodynamic electrical generator of the invention.

FIG. 2 is a breakaway view of a portion of the internal structure of the rotor of the generator of the invention exposed to the reactor side (the other part of the generator contains the coils and the iron cores).

FIG. 3 is a cross-sectional view of an induction coil of the rotor and stator of the invention.

FIG. 4 is a view of an axial cross-section of a radioactive isotope thermodynamic electrical generator of the invention.

FIG. 5 is a cross-section through the reactor/fuel rod (autoclave) capsule of a radioactive isotope thermodynamic electrical generator.

FIG. 6 is a drawing of the perforated disk used for the inlet and outlet of the capsule of the invention.

FIG. 7 is a drawing of the heat exchanger used in the invention.

FIG. 8 is a schematic of the fluid flow through a radioactive isotope thermodynamic electrical generator of the invention.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended to distinguish between similar elements and not necessarily for describing a sequential or chronological order. Moreover, relative terms like ‘front’, ‘back’, ‘top’ and ‘bottom’, and the like in the Description and/or in the Claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT(S)

The following description is not intended to limit the scope of the invention in any way as they are exemplary in nature, serving to describe the best mode of the invention known to the inventors as of the filing date hereof. Consequently, changes may be made in the arrangement and/or function of any of the elements described in the exemplary embodiments disclosed herein without departing from the spirit and scope of the invention.

Working Principle:

Thermal energy is produced by the attenuation of Alpha α or Beta β particles emitted by a radioactive isotope, manufactured in the form of “Metal Matrix Composite (MMC)”, “Mixed Metal Oxide (MMO)”, “Ceramic powder metallurgy”, “powder mixture of metal carbide”, “Metal powder alloy mixture” or the like, to form fuel pellets. The fuel pellets are contained within tightly sealed tubes made from very pure metal with high thermal conductivity and thermal resistance such as molybdenum, tungsten, tungsten carbide, tantalum etc. These are hence fuel rods of very high strength.

Radioactive isotope alpha or beta particles are attenuated by atoms of the ceramic compound, as a result of which their kinetic energy is converted into thermal energy.

As an example of how to prepare the metal ceramic, the radioactive isotope is ground and mixed with silica (SiO₂) or with another metal oxide like titanium dioxide TiO₂ or aluminum oxide Al₂O₃. The mixture is compressed and molded and then heated for a certain period of time. Afterwards, this mixture of oxide elements reacts with a silicate compound, in the form of a ceramic-like material having good mechanical and thermal characteristics. The resulting mixture has high tensile strength, high compressive strength and a high melting point; in addition to high chemical corrosion resistance, little erosion, and a stable anti-radiolysis reaction. As an overall result, this ceramic isotope fuel material has a long working life even under harsh conditions which prevents the release of radioactive materials into the circulating fluid and so eliminates the risk of pollution.

A pump/compressor pressurizes the liquid/gas and pushes it through a spiral cylindrical heat exchanger. The liquid/gas enters the radioisotope fuel capsule and passes through the radioisotope fuel rods where it is heated to become a high pressure, dry, saturated, steam-heated and pressurized gas, which then enters an eccentric compression chamber through an inlet port where it expands between two vanes, exerting pressure thereon which, in an effort to expand, turns a rotor, transforming thermal energy of the gas into mechanical energy. Apart from the eccentric cylinder defining the inner wall of this “eccentric” compression chamber, the reactor or autoclave capsule is cylindrically symmetrical, being made up essentially of concentric cylinders. The steam then leaves the compartment through an outlet port toward the heat exchanger where it condenses or cools down into a hot liquid/gas and then enters the pump/compressor (pump for liquid and compressor for gas) to start another cycle in this closed loop system. The rotating vanes of the drive motor turn the rotor and may, at the same time, play the role of a pump/compressor.

The generator is able to produce electric power ranging from a few KW to several MW depending on its size and the type or quantity of radioisotopes used. It is a reliable power source whether for small electric vehicles or for large trains or boats as well as for homes and businesses. Its possible utilization in space exploration is unlimited; it may be used as a reliable power source in space applications like satellites, where it offers compact size and more reliability than fragile and inefficient solar panels.

The unique design of the invention takes advantage of multifunctional components to increase efficiency. Besides reactor shielding, the spiral cylindrical heat exchanger, the cylindrical rotor and stator provide more shielding since they cover the total cylindrical body of the generator.

The drive motor of the generator experiences less fatigue and is highly reliable because of its slow-moving parts which are able to work under harsh conditions for tens of years without failure. Aluminum oxide fiber or silica (SiO₂ fibers), for example, are used as an electric insulator for rotor/stator coil windings. Unlike varnish, aluminum oxide and silicon dioxide fibers have high thermal and gamma ray resistance.

The generator of the invention works with various types of radioactive isotopes whether natural, synthetic or from low cost nuclear wastes. Beside its main role, each part of this generator plays the dual role of a biological shield against radiation.

The system can work in a large range of temperatures, with optimal temperatures lying between 300° C. and 700° C., depending on the type and quantity of the radioactive isotopes.

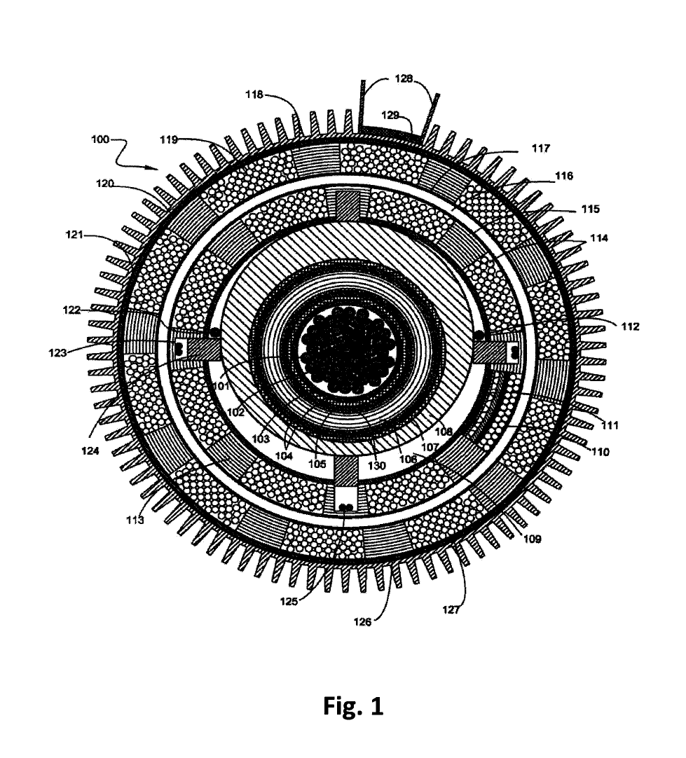

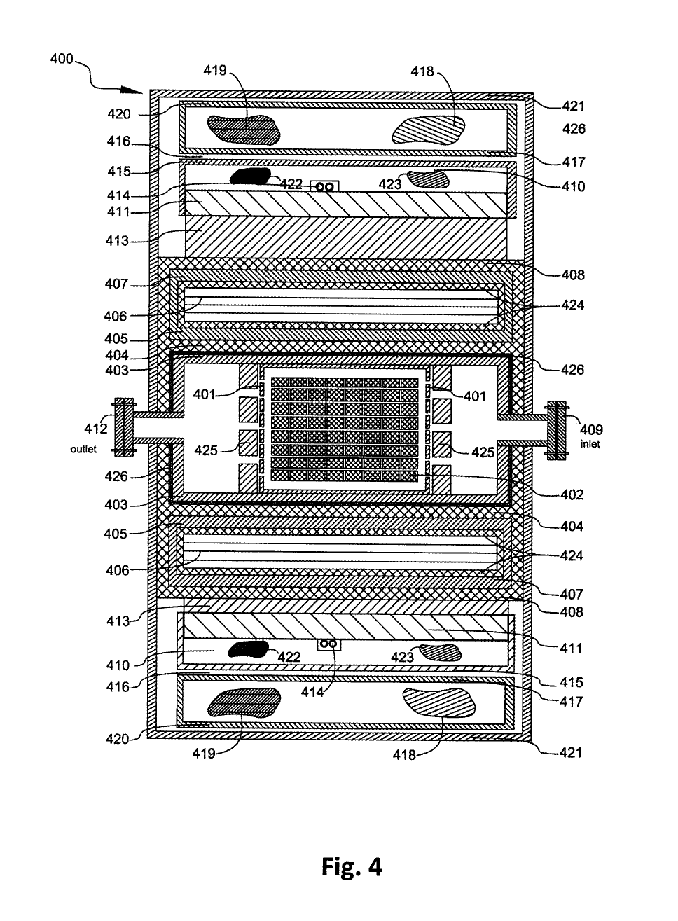

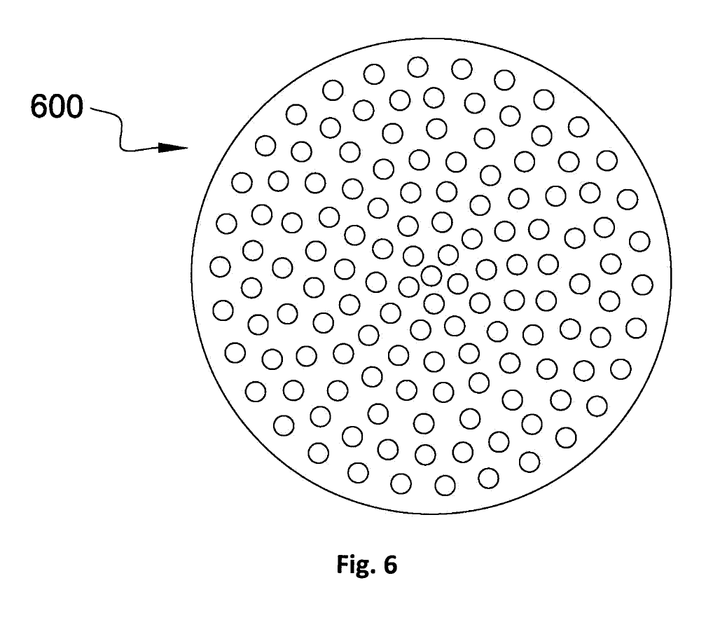

Referring now to FIG. 1 a first embodiment comprises a motor whose moving structure directly acts as the rotor of the electrical generator of the invention. The center of the motor comprises a cylindrical reactor chamber filled with fuel rods consisting of isotope metal ceramic or powder metallurgy ceramic 101, encased by cylindrical tubes 102 made from very pure metal (stainless steel ss. 316 or hest-alloy or niobium, in order to avoid embrittlement from prolonged exposure to radiation). The reactor or fuel capsule is surrounded by an autoclave cylindrical case 103 of similar pure metals so as to withstand high temperature and pressure conditions as well as neutron irradiation. In addition, cylindrical case 103 may optionally be covered with a heavy metal gamma ray protector. Gas or fluid entering through an inlet may pass through perforated bottom (top) plate 425, 600 into the reactor and exit from the reactor through similarly perforated top (bottom) plate 425, 600 and then the outlet (see FIGS. 4 and 6)

An advanced metallic (Titanium, Stainless Steel, Copper, Bronze, etc . . . ) spiral cylindrical heat exchanger 106 such as described in PCT/IB2011/002468, filed 17 Oct. 2011, which is incorporated by reference hereto, encases the fuel capsule. Metallic internal and external cylindrical enclosures 105, 107 (respectively) of heat exchanger 106 are covered on their inside by ceramic thermally insulating material 130. The outside of metallic enclosures 105 and 107 are covered with thermally insulating materials 104. The fuel capsule 103 is hence thermally insulated from the surrounding advanced cylindrical heat exchanger 106 to avoid thermal losses. The heat exchanger itself serves as an additional radiobiological shield.

Radioisotope fuel capsule 103 and the advanced heat exchanger 106 are contained within the cylindrical circular housing (“eccentric cylinder”) 108 eccentrically located in a cylindrical circular rotating structure (Rotor) 110 to form “eccentric” compression chamber 109. A number of movable vanes or blades 124, preferably four, slide radially inwards and outwards in slots 123 cut or formed in the cylindrical rotating structure. Small gas/vapor inlets and outlets 125 allow the rear part of radial slots 123 to be pressurized in order to overcome the centrifugal force acting on blades 124. Alternatively, these centrifugal forces can be offset by counterweights connected to the extreme ends of the vanes by a lever arrangement, the fulcrum of which being pivotably connected to the rotor 110. Movable vanes 124 are thus pushed against the walls of the “eccentric” cylindrical housing (eccentric cylinder) 108, with which they remain in contact to seal the compression chamber 109.

The present invention further provides inlet port 112 in the compression chamber wall in a manner similar to outlet port 122. The gas/vapor entering through inlet port 112 is discharged through outlet port 122. In operation, gas/vapor entering through inlet port 112 expands in the compartment of chamber 109 bounded by the pair of vanes 124 located on either side of said inlet port, thereby giving rise to a clockwise motion of the rotor around its central axis. The gas/vapor contained between pairs of vanes approaching outlet 122 is progressively compressed for discharge from outlet port 122.

In this first embodiment, the circular rotating structure serves as the rotor 110 of an electrical generator wherein a cylindrical stator 119 encases said cylindrical rotor, such rotor optionally encasing the inner workings of the motor of the invention thereby providing more biological shielding. In addition to its unique closed loop design, the advanced heat exchanger 106 provides this motor with many advantages and significantly raises its efficiency.

In other embodiments, the motor may be used directly to provide mechanical work. The motor of the invention, in particular, the eccentric design, may also serve as a motor powered by heat from another source, such as geothermal heat. In yet other embodiments, the motor and electrical generator may not both extend along the whole length of the reactor. The electrical generator may even be spatially separated from the motor, for example connected only by a shaft.

This radioisotope thermodynamic motor of the invention can work on Rankine or Brayton cycles. The pressurized liquid or gas (Rankine cycle (liquid) or Brayton cycle (gas)) runs through radioactive isotope capsule 103 where it is heated and then enters eccentric chamber 109 from inlet port 112 and expands between adjacent vanes or blades 124, thus generating mechanical power. This decreases the temperature and pressure of the vapor/gas (when part of the energy is transformed into mechanical energy by rotating the vanes) which is discharged from outlet port 122 toward heat exchanger 106. The system thus works in a closed loop.

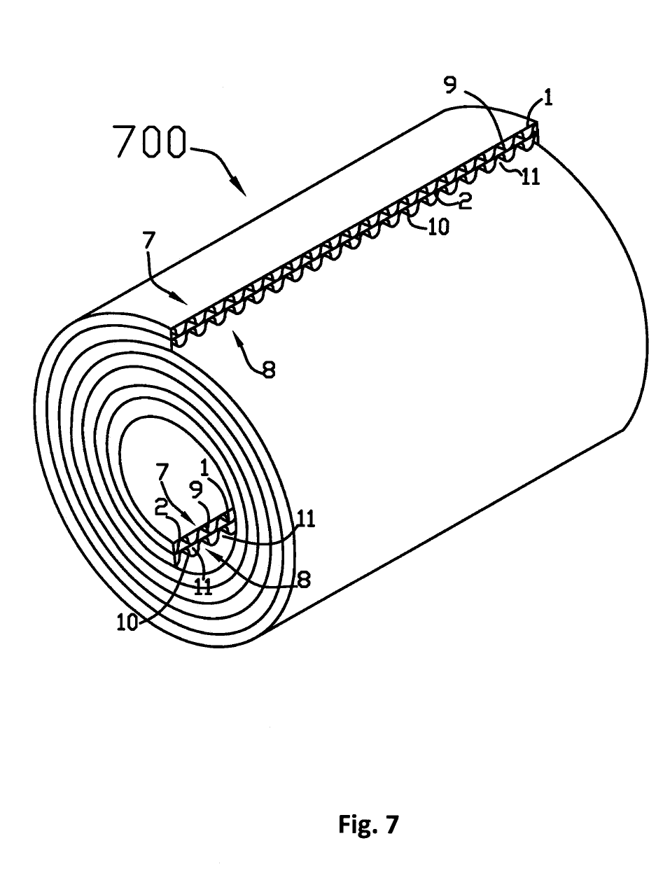

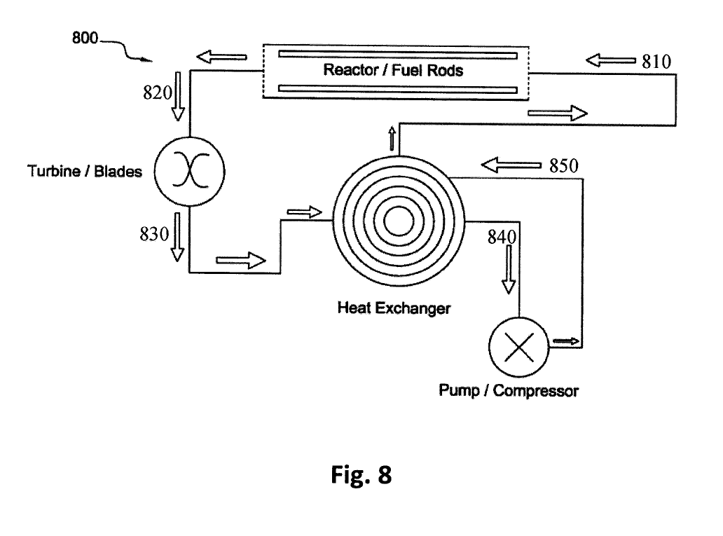

The advanced heat exchanger 106 (see also FIG. 7) plays a very important role in this closed loop system especially in a Rankine cycle (when using liquid or water in the system). When water enters the reactor/capsule, it is heated and transformed into steam. The steam then enters the drive motor from inlet 112 and expands into “eccentric” compression chamber 109, leaving it through outlet 122. Most of the steam energy is transformed into mechanical energy by moving the blades of the turbine. The driver fluid remains, however, in the form of hot steam. This hot steam then enters heat exchanger 106, which recovers the remaining heat from the steam and transforms it into hot water (instead of steam) before leaving the heat exchanger to a pump (see FIG. 8). The pump then pumps the hot liquid water again through a second flow channel of the advanced heat exchanger, where this hot water recovers the remaining heat from the steam (coming from the compression chamber) before entering the reactor again. If the heat exchanger 106 fails to condense the steam to a liquid state the pump will fail to pump the working fluid. Therefore, an efficient heat exchanger 106 is required such as that described in PCT/IB2011/002468. This design provides an efficient counter flow heat exchanger 106 of various rectangular, cylindrical or spiral shapes, having two or more flow channels and at least four inlets/outlets.

Inner encasing 111 of the rotor 110 is made from KEVLAR™ aramid (a para-aramid synthetic fiber), an epoxy fiber glass composite as a mechanical fixator and protection against vibrations. Likewise, outer encasing 115 of the rotor 110 and inner encasing 117 of the stator 119 are made of a very thin layer of the same materials (i.e. layer of KEVLAR™ aramid fiber textile, M5 fiber textile, glass fiber textile, silica fiber textile, carbon fiber textile composite with epoxy resin or polyester resin). Of course, a structure of metal alone will not have an insulating effect. Therefore, any metal component must be combined with a thermally insulating element as would be readily understood by someone of ordinary skill in the art.

Small clearance 116 between the rotor 110 and the stator 119 separates the rotating rotor 110 from the stationary stator 119.

The radioisotope thermodynamic electrical generator comprises a first metallic external casing 120 which may be followed by another casing with cooling fins 121 and resistors 128. The role of resistors 128 is to avoid superheating of the generator 100. Unused electrical output will be converted into heat by resistor 128, the heat being dissipated by the fins of casing 121. The two external casings 120, 121 are electrically insulated by means of an electrical insulator, i.e. thin mica sheet 127.

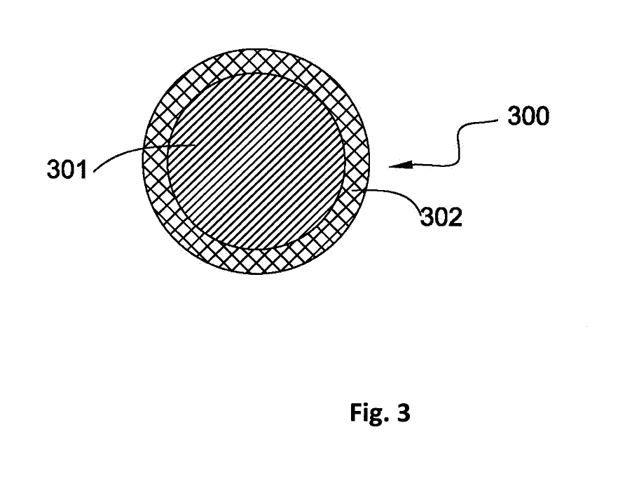

In one embodiment of the invention, in order to generate electricity, rotor 110 and stator 119 both contain coils 114 and magnetic iron sheets 113, 118, arranged in a way known in the art. Iron sheets 113, 118 and electro-conductive coils 114 are contained within the rotor internal case 111 and external case 115, respectively. The coils 114 are coated with an electric insulator made from special long-lasting aluminum oxide fibers, or silica fibers (see also FIG. 3). Aluminum Oxide fibers make up an electrically insulating material with high resistivity and high corrosion resistance, exhibiting good thermal conductivity and providing thermal shock resistance. It has a very high melting temperature of about 2050° C. and maintains its mechanical and thermal properties at temperatures exceeding 800° C. for a relatively long period of time. Because Aluminum Oxide fibers have an exceptionally high modulus of elasticity combined with high mechanical strength, their dielectric and mechanical properties are essentially unaffacted by harmful radiations including gamma rays.

Some properties of Aluminum Oxide Fibers:

| | Tensile | Young's | | Specific | Specific | Fiber |
|---|---|---|---|---|---|---|
| | Strength | modulus | Relative | Strength | modulus | diameter |
| Material | (GPa) | (GPa) | density | (GPa) | (GPa) | (μm) |
| A-Alumina, AL₂O₃ | 1.7 | 380 | 3.95 | 0.43 | 96 | 20 |

These dielectric, thermal and mechanical properties are excellent for working under conditions of large temperature changes from below 0° C. to over 400° C. Coils insulated or coated with aluminum oxide fibers therefore work reliably under very harsh conditions. The high modulus of elasticity and high mechanical strength of aluminum oxide fibers enables the electrically conductive coils to work well during positive and negative acceleration, making them highly resilient against vibrations. Further, the aluminum oxide fibers possess very high dielectric strengths and excellent thermal conductivity with no defects. In addition, aluminum oxide fibers are highly heat resistant. Thus, in the context of providing insulation for conductive wires, aluminum oxide fibers are extremely resistant to melting and, unlike varnish or resin, do not flow upon exposure to elevated temperatures. The insulating coating of the invention is also highly resistant to wide fluctuations in temperature due to its flexibility. This is an important property because conductive wires, used for example, in electrical equipment, are often subjected to extreme temperature variations caused by a varying flow of electrical current. Because aluminum oxide fibers are used, the electrical generator of the invention requires little maintenance and can work for a very long period without failure.

In another embodiment, the aluminum oxide fibers are applied in fabric or textile form. Such forms may comprise tapes made from aluminum oxide fibers.

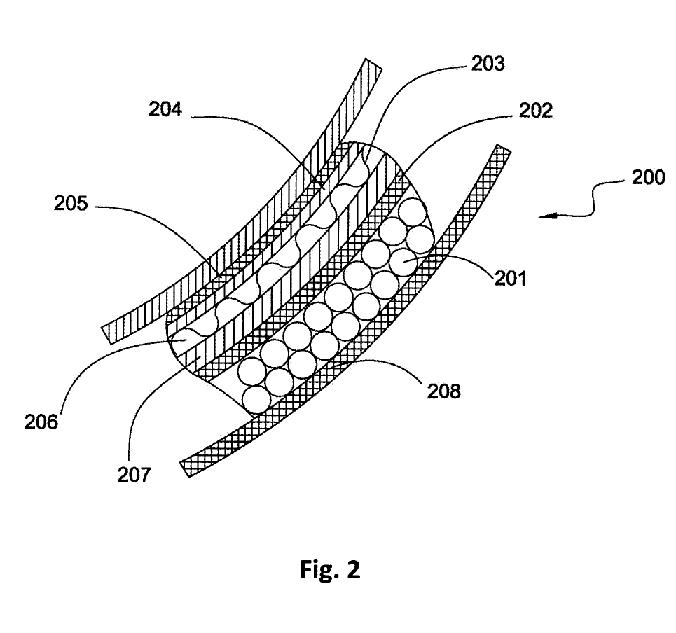

Referring now to FIG. 2, the internal structure of rotor 200 comprises a special thermal insulation to keep it relatively cool. A cover of highly thermally insulating material such as aluminum oxide textile fibers 205 covers the internal casing 111 of the rotor. It is followed by special undulating/corrugations in an S profile 203 defining vacuum spacing 206 between two metallic sheets 204, 207, followed by a thin layer of KEVLAR™ aramid or an epoxy resin 202 acting as mechanical fixator of the rotor coil. Thermal conduction is minimized by vacuum spacing 206, while metallic sheets 204, 207, i.e. stainless steel acting as mirrors, reflect infrared radiation back to the interior of the reactor. The outer layer 115, 208 of the rotor is made from a very thin layer of KEVLAR™ aramid or epoxy resin, acting as mechanical fixator of coil 201 against vibration. Since KEVLAR™ and Epoxy contain hydrogen, and since hydrogen is a neutron moderator (it is used as heavy water in nuclear reactors), this thin layer does not allow any neutrons to enter the coil environment and cause ionization of the air.

Referring now to FIG. 3, a cross-sectional view of one of the wires making up the electro-conductive coils of rotor 110, 200 and stator 119 may be seen. Wire 301, made for example from copper, is electrically insulated by layer 302, comprising either the special long-lasting aluminum oxide fibers described above, silica fibers, or S5 fiberglass.

Referring now to FIG. 4, a cross-sectional view of a radioactive isotope thermodynamic electrical generator of the invention may be seen, showing in more detail the fuel capsule container 401 with perforated plates 425 and fuel rods 102, 402 in reactor or autoclave capsule/case 103, 403. The reactor is surrounded by neutron deflector and absorber layer 426, comprising for example a layer of Beryllium 9, Boron 10, or diamond. This is followed by thermally insulating materials 104, 404; internal thermal insulators 130, 424 and internal metallic case 105, 405 of the advanced spiral heat exchanger 106, 406 and its external metallic case 107, 407; and thermal insulators 104, 408 between heat exchanger and eccentric cylinder. Inlet 409 and outlet 412 of the reactor fluid penetrate through perforated plates 425 to fuel rods 402. The figure also shows “eccentric” cylinder 108, 413; turbine blades or vanes 124, 411 with gas pressure inlets and outlets 125, 414 for keeping the blades in close proximity to the “eccentric” cylinder; rotor 410 with its iron sheets 422 and electroconductive coils 423. Rotor 410 is encased with a very thin layer 115, 415 of KEVLAR™ aramid fiber textile, M5 fiber textile, glass fiber textile, silica fiber textile, carbon fiber textile composite with epoxy resin or polyester resin acting as mechanical fixator of the rotor coils against vibrations. Rotor 410 is separated by clearance 116, 416 from a similar layer 117, 417 forming the inner encasing of the stator 119. The same kind of thin layer of KEVLAR™ aramid, epoxy resin, etc., covers also the outer encasing 126, 420 of the stator 119, the layers 117, 417, 126, 420 acting as mechanical fixator against vibrations of the stator coils.

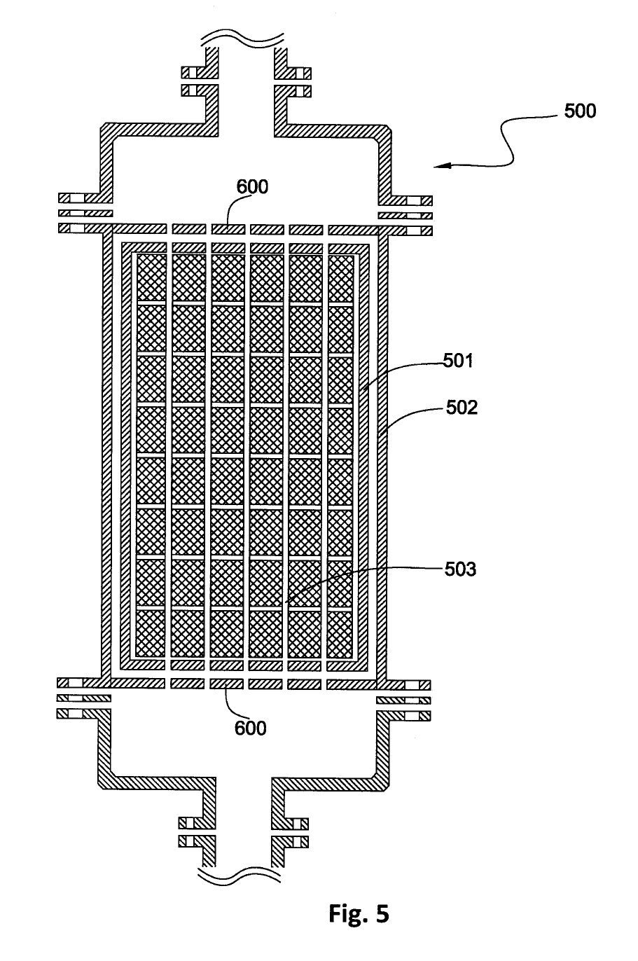

Referring now to FIG. 5, an enlarged longitudinal cross-section through the autoclave (reactor/fuel) capsule 500 may be seen. The capsule 500 is made up of perforated top and bottom plates 600 (see also FIG. 6) of reactor encasing 502 through which the reactor fluid enters and exits, very pure metal case 501, made from ss. 316, hest-alloy or niobium, thus flowing along spacings 503, separating the fuel rods which contain the fuel pellets. The perforated mechanical plate forming inlet and outlet of the reactor/capsule is shown in the enlarged drawing of FIG. 6.

Referring now to FIG. 7, an embodiment of the spiral heat exchanger comprises two rectangular sheets 1, 2 spaced apart by two corrugated sheets 9, 10. The first corrugated sheet 9 is interposed between the rectangular sheets 1, 2 to form the first flow channel 7 with a plurality of passageways 11. The second corrugated sheet 10 is welded on the upper side of the second rectangular sheet 2 in such a way that when the first flow channel 7 is wound, it forms the cylindrical void and the lower side of the first rectangular sheet 1 covers the rear end of the second corrugated sheet 10 to create the second flow channel 8. Thus, both flow channels share the same sheet as a separating heat transfer wall. Both rectangular sheets serve as a separating heat transfer wall between the two fluids, which is a significant advantage when used within the generator 100 of the invention.

Referring now to FIG. 8, the cycle of fluid flow inside the thermodynamic generator 100 of the invention comprises, for example, water 810 entering the reactor (the autoclave capsule 500) with the fuel rods, wherein it is transformed to steam 820, which, upon entering the eccentric compression chamber 109, drives the motor 100, whereby some of its thermal energy is transformed into mechanical energy. Cooler steam 830 coming from the compression chamber 109 enters the heat exchanger 106, wherein it is transformed to hot water 840 in the first flow channel 7. Hot water 850 is then pumped through the second flow channel 8, wherein it recovers additional heat before entering the reactor again.

In the generator 100 of the invention, radiation damage to the thermal insulating means by fast neutrons is minimized. As a rough estimate shows, the fast neutron dose in the shield is so low that carbon-fiber reinforced graphite can be used without reservation as the reactor shield material.

The invention thus provides a highly reliable electric power generator 100 that makes use of a radioactive isotope as the energy source. All kinds of radioactive isotopes can be used as a heat source including free gamma ray radioisotopes or radioactive wastes.

The drive motor 100 of the invention experiences less fatigue and is more reliable because of its slow-moving parts: The vanes of this thermodynamic generator rotate relatively slowly, for example 300-400 rpm or even more slowly, in contrast to those in high speed turbines in which high vane speeds can stress the generator, leading to damage, shorter lifespan, and possibly even decreased energy output apart from creating more noise.

The thermodynamic electrical generator 100 according to the invention is therefore able to work under harsh conditions for tens of years without failure. In another aspect of the invention, Aluminum oxide fiber/Silica oxide SiO₂ fibers or S5 fiberglass may be used as an electrical insulator for rotor/stator coil windings. Unlike varnish, Aluminum oxide fiber and silica oxide fibers have high thermal resistance and provide more resistance to gamma rays.

The invention is significant because a vehicle equipped with a generator rather than a battery is believed to be the most sustainable solution for the future. Vehicles equipped with the thermodynamic generator of the invention do not need storage batteries.

In another embodiment, the drive motor of the invention may be directly connected to move the wheels of a vehicle using a gear box, thus averting the necessity of transforming the motion into electrical power first, which then is used to power an electric motor on the electric vehicle. Thus, the motors of current vehicles can be replaced by the motor of the invention. Advantageously, because no batteries, no fuel reservoir, or separate electric motor (and associated electronics and related assessories) are required, a vehicle using the motor of the invention is lighter and so more efficient.

In another embodiment, if the thermodynamic generator is used as drive motor and the rotor and stator are not included in its structure, an electric dynamo could be added for the car to optionally produce electricity when idling or when need be.

It is well known as well that if there is no electrical load on an electric generator, all its power may be transformed into mechanical power. Therefore the generator of the invention may be used either as electrical generator or as a drive motor.

Preferrably, the motor of the invention is powered by a safe type of radioactive isotope such as Cadmium 113m which is abundant and does not present any appreciable risk to public safety and which may also be produced on a large scale in current nuclear reactors.

In an advantage, this generator 100 is highly efficient, exceptionally safe and reliable.

In an advantage, this generator 100 can also be considered as means of nuclear waste disposal. As such, it serves as a self-cooled grave for these harmful nuclear wastes where, at the same time, it can provide electricity efficiently for a very long period of time. Consequently, nuclear wastes removed from a nuclear power plant can be “buried” in this reactor where they can produce large quantities of electricity.

In an advantage, this generator 100 of the invention works on a wide range of radioactive isotopes whether natural, synthetic or low cost nuclear wastes.

In an advantage, several key parts of this generator 100 play the role of a biological shield against radiation.

In an advantage, a highly variable energy density may be selected for the fuel rods used in the invention, which depends on the half-life and energy levels of the isotopes. This is because the isotopes, whether natural or synthetic, have numerous half-lives which vary from less than 1 year to more than 100 years. Usually, the shorter the half-life, the higher the energy density.

In another advantage, the size of the generator 100 can vary from few centimeters in diameter to tens of meters depending on the desired power output.

It will be understood that the above description of the present invention is susceptible to various modifications, changes and adaptations, and the same are intended to be comprehended within the meaning and range of equivalents of the appended claims. It should be appreciated that the particular implementations shown and herein described are representative of the invention and its best mode and are not intended to limit the scope of the present invention in any way. As will be appreciated by skilled artisans, the present invention may be embodied as a system, a device, or a method. Moreover, the invention contemplates the use, sale and/or distribution of any goods, services or information having similar functionality described herein.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements described in the instant specification.

Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure. Other characteristics and modes of execution of the invention are described in the appended claims. Further, the invention should be considered as comprising all possible combinations of every feature described in the instant specification, appended claims, and/or drawing figures which may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-à-vis the public or third parties, no express or implied license is granted to prepare derivative works based on this patent specification, inclusive of the appendix hereto and any computer program comprised therein. Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

What is claimed is:

1. A motor comprising:
a. a shielded fuel capsule adapted to contain radioactive fuel, preferably spent fuel in the form of fuel rods, wherein top and bottom are perforated to allow pressurized gas and/or vapor to pass through;
b. a sealed, pressure resistant and insulated autoclave capsule, wherein said autoclave capsule contains the fuel capsule;
c. a thermal insulation applied over the autoclave capsule;
d. a heat exchanger encasing the autoclave capsule;
e. an eccentric cylinder surrounding the heat exchanger and autoclave capsule, the eccentric cylinder having an outer cylindrical surface forming a first wall of an asymmetric compression chamber and an inner cylindrical opening centered about a central axis, the heat exchanger and insulated autoclave capsule being disposed in the opening;
f. a rotor having an inner cylindrical surface forming a second wall of the compression chamber, the rotor mounted to rotate about the central axis around the stationary eccentric cylinder; and
g. a plurality of movable vanes adapted to slide substantially radially inwards and outwards in slots formed in the inner wall of the rotor; wherein either gas inlets/outlets in the slots adapted to receive pressurized gas or springs impart a bias to the vanes to keep the vanes abutted in a sealed relationship against said eccentric cylinder;
h. an inlet port for gas and/or vapor heated in said fuel capsule, wherein entering gas and/or vapor is able to expand in a compartment of said compression chamber bounded by a pair of vanes, to induce rotational motion of the rotor about said central axis; and
i. an outlet port adapted to discharge gas and/or vapor from the compression chamber to said heat exchanger.

2. The motor of claim 1, wherein the working gas and/or vapor received from the compression chamber passes through the heat exchanger to pre-heat the gas and/or vapor prior to passing through the fuel capsule.

3. The motor of claim 1, wherein the heat exchanger has the form of a spiral cylindrical roll, and wherein the heat exchanger covers the autoclave capsule.

4. The motor of claim 3, wherein the motor is adapted to do mechanical work.

5. The motor of claim 3, wherein the motor is mounted to drive an electrical generator.

6. The motor of claim 5, further including a stator which is stationary with respect to the rotor, wherein the rotor and stator enclose the heat exchanger, and wherein the rotor and stator thus provide additional radiobiological shielding against radioactive radiation emitted from the fuel capsule.

7. An electrical generator powered by the motor of claim 5, wherein the rotor and stator are separate from the motor.

8. The motor of claim 1, wherein the fuel rods are contained in very pure metal tubes to minimize embrittlement from prolonged exposure to radioactive radiation.

9. The motor of claim 1, wherein the autoclave capsule is made from a very pure metal in order to withstand high temperature and high pressure conditions as well as neutron irradiation.

10. The motor of claim 1, wherein the autoclave capsule is surrounded by a neutron deflector and absorber layer.

11. The motor of claim 1, wherein the autoclave capsule optionally covered with a heavy metal gamma ray (y) protector shield.

12. The motor of claim 1, wherein the rotor is adapted to rotate at a speed below 400 rpm to reduce wear.

13. The motor of claim 1, wherein the rotor is adapted to rotate at a speed of about 300-400 rpm.

14. The motor of claim 1, wherein the rotor is encased by layers of materials selected from a group of materials consisting of a para-aramid synthetic fiber textile, M5 fiber textile, glass fiber textile, silica fiber textile, and carbon fiber textile composite with epoxy resin or polyester resin, the said layers acting as mechanical fixator and protection against vibrations.

15. The motor of claim 5, wherein the inner encasing of the stator is made from a layer of materials selected from a group of materials consisting of a para-aramid synthetic fiber textile, M5 fiber textile, glass fiber textile, silica fiber textile, and carbon fiber textile composite with epoxy resin or polyester resin, the said layer acting as mechanical fixator and protection against vibrations.

16. The motor of claim 5, wherein layers of materials selected from a group of materials consisting of aluminum oxide fibers, silica fibers, glass-S fibers and M5 fibers, provide for electrical insulation of rotor and stator coils.

17. The motor of claim 5, wherein aluminum oxide fibers provide electrical insulation of rotor and stator coils.

18. The motor of claim 1, adapted such that the optimal temperatures of the gas and/or vapor leaving the fuel capsule are in the range between 300° C. and 700° C.

19. The motor of claim 5, adapted so as to generate electrical power output ranging from kW to MW, depending on the type and quantity of radioisotopes used.

20. The motor of claim 1, wherein the character, quantity and disposition of radiation protection is selected to provide safe and reliable operation for tens of years.
